(19) United States
(12) Patent Application Publication
(10) Pub. No.: US 2007/0009563 A1
(43) Pub. Date: Jan. 11, 2007

(54) PROCESS FOR COATING FIBER OR FABRIC WITH INSECTICIDE USING A TEMPERATURE OF 150°C-190°C FOR DRYING

(76) Inventor: Rung Hataipitisuk, Bangalne District (TH)

Correspondence Address: BRENC LAW;ANDREW BRENC, P.O. BOX 155, ALBION, PA, 16401-0155, US

(21) Appl. No.: 11/422,103

(22) Filed: Jun. 5, 2006

(30) Foreign Application Priority Data
Jul. 6, 2005 (TH) 102110

(51) Int. Cl. B32B 27/04; A01N 25/00

(52) U.S. Cl. 424/405; 442/123

(57) ABSTRACT

Conventionally, fiber coated with insecticide is dried at a temperature not higher than 100° C., which prevents the insecticide from degrading. However, according to the present invention, polyester fabric, or other fabrics or fibers, is dipped in an insecticide mixture comprising a pyrethroid substance or other insecticide, a thickener, a fiber stabilizing enhancer, and water. The fabric or fiber is then dried at a temperature of 150° C.-190° C. without degradation of the insecticide, thereby reducing manufacturing cost and time to a great extent.

### CROSS-REFERENCE TO RELATED APPLICATIONS

This application claims priority to Thai Patent Application 102110, which was filed in Thailand on Jul. 6^{th}, 2005, and which is hereby incorporated by reference in its entirety.

### FIELD OF THE INVENTION

The present invention is in the field of chemistry, and more specifically the present invention is in the field of methods of chemical pest control.

### BACKGROUND

Malaria is an epidemic found in more than 100 countries. About 40% of the world population lives in areas at risk of malaria infection. Survey reports have found that 20% of people in the risk group are infected with malaria, especially in African countries. These countries have not less than 1 million people per year infected by malaria. The population group that dies as a result of malaria are mostly adolescents and children.

Insecticides that were initially used for controlling insects and mosquitoes in households were those such as diphenyl trichloroethane (DDT), hexachloride cyclohexane (HCH), and malathion. Mosquitoes thereafter began to acquire resistance to those insecticides. Moreover, such substances may cause cancer and may leave toxic residue in the soil and water. The substances can also accumulate in fat tissues of plants and animals. Other types of insecticide have been developed to replace those early chemicals.

Pyrethroids are another group of chemicals developed and used in the agricultural industry and for controlling insects in households widely because of their efficiency in killing insects, such as mosquitoes, quickly, and because of their low toxicity level to mammals and the environment. Pyrethroids are therefore used in coating fabric or net.

The process for coating an insecticide on fiber or fabric in order to control insects has been developed continuously. The coating methods and formulae for mixing insecticides differ from one process to another.

U.S. Pat. No. 4,765,982 (Ronning) taught insecticide adhering to fiber with a rough surface. The insecticide used was in an encapsulated form.

U.S. Pat. No. 5,089,298 (McMally and Samson) applied amylopectin on polyester fabric with permethrin in order to protect the insecticide from washing. However, amylopectin can dissolve in water and therefore give no resistance to washing.

WO 95/17091 (Tucci) described a release of DEET encapsulated in starch adhered on fabric, with the addition of a silicone polymer substance to increase efficiency in resisting washing.

U.S. Pat. No. 5,884,418 (Mc Nally) described a process and system for coating clothes with insect repellant by loading clothes into a rotating machine with a spray nozzle for spraying an emulsion of permethrin and water onto the clothes. This process is similar to a process of dry cleaning.

U.S. Pat. No. 5,198,287 (Samson) teaches a coating on the inside surface of a tent, with a mixture having special properties for repelling water, retarding fire, and functioning as an insecticide through the incorporation of permethrin. In this method, permethrin is protected from oxygen by the plastic on the outside of the tent. The insecticide mixture is active for more than 6 months.

U.S. Pat. No. 3,859,121 (Yeadon et al.) is related to a coating of fabric with insect repellant that includes compositions such as piperonyl butoxide and pyrethrin, wetting agents, thickeners, and substances for preventing movement of piperonyl butoxide and pyrethrin.

At present, insecticide products are sold to the population for use in coating fabric and mosquito nets by hand, after which those fabrics and nets are placed in a shady area to dry. However, fabric or mosquito nets coated with this method are effective for killing mosquitoes for only 2-3 months. In addition, when they are washed 1-2 times, the insecticides are removed almost completely and the users need to do the dipping every 2-3 months, requiring extra expense and placing more burden on the users.

Olyset net produced by Sumitomo uses a process of dipping polyethylene fiber in a permethrin solution in the step of manufacturing of the fiber. The net finished with this method has a long service life but is very expensive. Moreover, this method cannot be applied to polyester fiber.

Permanet uses a process of dipping polyester fabric or nets in a mixture of insecticide with a film builder and then subjecting the fabric or net to a heating at temperature of 80° C. using an industrial machine. Fabric or nets produced with this method can resist washing up to 6 times.

### SUMMARY OF THE INVENTION

The present invention is related to a process for coating polyester fiber or fabric with an insecticide which can be a pyrethroid substance in order to efficiency kill insects for a longer period of time and increase washing resistance. This is achieved by dipping the fiber or fabric in an insecticide mixture and then passing the fiber or fabric through a heat-drying process at a temperature 150° C.-190° C.

### DETAILED DESCRIPTION

Pyrethroid or synthetic pyrethroid is a substance which is highly effective in killing insects quickly, but with very low toxicity to mammals and the environment because of fast degradation in the soil and resistance to degradation when exposed to light. This substance was developed for use in dipping or coating fiber or fabric. A number of reports have found that existing insecticides, and methods of dipping or coating with insecticides, can cause respiratory system irritation and headaches because most insecticides used have foul smelling oil or organic solvents. These substances stay as a residue on fiber or fabric after manufacturing.

The pyrethroid used for dipping fiber or fabric is generally in the form of an emulsion, which is a milky liquid. An emulsion of oil in water is used to dip fabric because that emulsion provides a good adhering power to fiber. However, pyrethrin (pyrethrum), allethrin, and phenothrin are not appropriate for dipping fabric because they easily degrade when they are exposed to light. Pyrethroid substances that are appropriate for dipping fiber or fabric are:

1. Permethrin: this substance is generally used in the agricultural industry and in controlling insects in households because it is highly efficient in controlling insects and has no toxicity or side effects.

2. Deltamethrin: this substance is generally used in the agricultural industry and in controlling insects in households. This type of pyrethroid substance is widely used in China for dipping blankets. It is more than 30 times as effective as permethrin with small dosages, but it is very expensive. This substance is more toxic to insects and humans than permethrin, and it must be used in a very small amount. It can cause irritation or itching while dipping or using, depending on the type of fiber and the formula of the solution. There are reports that people who sleep in polyethylene mosquito nets coated with deltamethrin in highly concentrated suspension form and in cotton mosquito nets coated with water solutions of deltamethrin powder suffer itching on their faces.

3. Lambda-cyhalothrin: this insecticide has been developed and used widely. The general properties are similar to deltamethrin. There are reports that lambda-cyhalothrin can cause nose itching on people who sleep in mosquito nets freshly treated with the insecticide.

4. Cyfluthrin: this substance is more toxic to insects than permethrin but less toxic than deltamethrin and lambda-cyhalothrin. So far no side effects have been reported.

In addition, there are other pyrethroid substances that have been used in dipping fabric in order to study their effectiveness and safety, such as cypermethrin, flumethrin, biphenthrin, ethofenprox, esfenvalerate, and alpha-cypermethrin.

The process for coating fiber or fabric with insecticide according to the present invention is related to the process of coating and the composition of the insecticide mixture.

A process for coating fiber or fabric according to the present invention uses industrial machinery for production. This can be done by dipping fiber or fabric in an insecticide mixture and then exposing the fiber or fabric already treated with insecticide to temperature of 150° C.-190° C., which can reduce the length of time used in the process of the invention relative to conventional techniques. This helps produce a large amount of fiber or fabric coated with insecticide in a short time and reduces the manufacturing cost.

Insecticide mixtures according to the present invention use insecticide based on a pyrethroid substance with the appropriate properties for quick extermination of insects and with a low propensity to dissolve in water, which prevents the mixtures from coming off when the coated fabric is washed. Insecticide mixtures of the present invention can use water as the only solvent to obtain an insecticide solution in the form of a suspension in water. A thickener is used as a stabilizer for the insecticide mixture in order to prevent precipitation and diffusion, and to avoid the danger and odor of any organic solvent.

When fiber or fabric is dipped in an insecticide mixture, the insecticide in the form of solid particles suspended in the water coats and attaches to the surface of the fiber with a film layer of thickener and stabilizer coated on top. When heated at a high temperature in a drying step, the insecticide melts into liquid and is absorbed into the fiber. At the same time, a part of the insecticide is also absorbed into the layer of thickener film and permeates through to the outer surface.

Raw materials used in dipping insecticide mixtures according to the present invention can be materials such as fabric made from cotton, nylon, polyethylene, and polyester. The process for coating insecticide mixtures can be executed in any step, either before spinning, weaving, and knitting, or in the final steps of the fabric dipping process as well.

High temperatures in the range of 150° C.-190° C. are used in the process of fabric drying according to the present invention to create fiber stability and strengthen chemicals used for stabilizing that fiber in order to make the insecticide adhere to the fiber. However, this temperature range affects the insecticide degradation. For example, coating of a polyester mosquito net with deltamethrin requires a deltamethrin concentration of 55 mg/m². The material is then dried at various temperatures using the same length of time for drying.

| Deltamethrin Mixtures: | (weight/weight) |
|---|---|
| Deltamethrin | 0.35% |
| Perfluoro acrylate | 0.3% |
| Resin | 1% |
| Polyacrylate | 2% |
| Thickener | 0.2% |
| Add water up to | 100% |

TABLE 1
Quantity of deltamethrin on the fabric of mosquito net after drying at
various temperatures:

| Drying Temperature (° C.) | Deltamethrin (mg/m²) |
|---|---|
| 150 | 55 |
| 160 | 55 |
| 170 | 55 |
| 180 | 37 |
| 190 | 25 |

In Table 1, it is found that using temperatures higher than 170° C. for fabric drying causes deltamethrin degradation. The ratio of deltamethrin degradation is also affected by the length of time for drying.

When mosquito nets that have been coated with deltamethrin and dried at various temperatures are washed by using the World Health Organization (WHO) washing procedure standard, it is found that the drying temperatures used result in different washing resistances as shown in Table 2.

TABLE 2
Quantity of deltamethrin on the fabric of mosquito net before and
after washing:

| | Deltamethrin (mg/m²) | | | | |
|---|---|---|---|---|---|
| | | | After | After | After |
| Drying | | After | Washing | Washing | Washing |
| Temperature | Before | Washing 5 | 10 | 15 | 20 |
| (° C.) | Washing | Times | Times | Times | Times |
| 150 | 55 | 40 | 32 | 16 | 10 |
| 160 | 55 | 42 | 36 | 19 | 12 |
| 170 | 55 | 44 | 38 | 22 | 16 |
| 180 | 37 | 26 | 20 | 16 | 4 |
| 190 | 25 | 19 | 15 | 8 | 4 |

In Table 2, it is found that the quantity of deltamethrin gradually decreases as the number of washes increases. In addition, the temperatures used for drying the fabric in the manufacturing process affect washing resistance. That is, the fabric which is dried at higher temperature can resist washing better than the fabric that is dried at lower temperature.

When testing the fabric of mosquito nets that have been washed in order to find out the efficiency in repelling or exterminating mosquitoes, it is found that the efficiency in mosquito extermination is decreased when the number of washing times increases, as shown in Table 3.

TABLE 3
Efficiency in killing mosquitoes after washing the mosquito net coated
with deltamethrin:

| | Efficacy in killing mosquitoes (%) | | | | | | | | | |
|---|---|---|---|---|---|---|---|---|---|---|
| | Before | | After Washing | | After Washing | | After Washing | | After Washing | |
| Drying | Washing | | 5 Times | | 10 Times | | 15 Times | | 20 Times | |
| Temperature | | % | | % | | % | | % | | % |
| (° C.) | % KD | mort. | % KD | mort. | % KD | mort. | % KD | mort. | % KD | mort. |
| 150 | 100 | 100 | 100 | 100 | 100 | 100 | 100 | 90 | 95 | 82 |
| 160 | 100 | 100 | 100 | 100 | 100 | 96 | 100 | 90 | 96 | 80 |
| 170 | 100 | 100 | 100 | 100 | 100 | 100 | 100 | 90 | 95 | 82 |
| 180 | 100 | 98 | 100 | 82 | 95 | 62 | 82 | 22 | 84 | 0 |
| 190 | 100 | 96 | 100 | 68 | 95 | 18 | 44 | 0 | 16 | 0 |

The efficiency test for mosquito net dipped in insecticide/insect repellent is done by letting mosquitoes rest on the mosquito net for 3 minutes and then catching the mosquitoes, placing them in a clean container, and observing them to see which of the following conditions apply:

1. % Knock down (% KD): the number of mosquitoes that cannot move after 60 minutes, in some embodiments, must be more than 80%.

2. Mortality (% mort.): the mortality rate of mosquitoes after 24 hours, in some embodiments, must be more than 95%.

Dipping the fabric in the insecticide mixture according to the present invention can be done by hand. The fabric coated with the insecticide mixture is then spun to remove the excess solution, dried in a shady area, and subjected to heating or heated by using a device with a heating surface such as an iron or a heating roller. Heating can enhance distribution and permeability of the insecticide through the outer surface of the fiber and improve the strength of chemicals coated on the fabric or fiber.

The quantity of insecticide in the formula of insecticide mixture according to the present invention can be adjusted by increasing or decreasing the quantity of water. The ratio of the insecticide to thickener, in some embodiments, is a fixed ratio and the quantities of other compositions, in some embodiments, are fixed.

The quantity of insecticide used is determined based on the ability to absorb water of the fabric or fiber or the required quantity of insecticide to be left on the fabric.

The formula of solution according to various embodiments of the present invention comprises 4 portions as follows:

1. Insecticide from pyrethroid group such as deltamethrin, esfenvalerate, ethofenprox, biphenthrin, permethrin, and cyhalothrin which are quickly active and have a high boiling point.

2. A thread stabilizing enhancer, for example, a compound of perfluoro acrylate, resin, adhesive, and polyacrylate.

3. Thickeners such as starch, gum, and titanium dioxide.

4. Solvents, for example, water.

### EXAMPLE 1

### Compositions of Deltamethrin Mixture (Weight/Weight)

| | |
|---|---|
| Deltamethrin | 0.35% |
| Perfluoro acrylate | 0.3% |
| Resin | 1% |
| Polyacrylate | 2% |
| Thickener | 0.2% |
| Add water up to | 100% |

### EXAMPLE 2

### Compositions of Permethrin Mixture (Weight/Weight)

| | |
|---|---|
| Permethrin | 1.58% |
| Perfluoro acrylate | 0.3% |
| Resin | 1% |
| Polyacrylate | 2% |
| Thickener | 0.9% |
| Add water up to | 100% |

### EXAMPLE 3

### Compositions of Alpha-Cypermethrin Mixture (Weight/Weight)

| | |
|---|---|
| Alpha-cypermethrin | 0.31% |
| Perfluoro acrylate | 0.3% |
| Resin | 1% |
| Polyacrylate | 2% |
| Thickener | 0.18% |
| Add water up to | 100% |

### EXAMPLE 4

### Compositions of Biphenthrin Mixture (Weight/Weight)

| | |
|---|---|
| Biphenthrin | 0.2% |
| Perfluoro acrylate | 0.3% |
| Resin | 1% |
| Polyacrylate | 2% |
| Thickener | 0.12% |
| Add water up to | 100% |

### EXAMPLE 5

### Compositions of Cyfluthrin Mixture Solution (Weight/Weight)

| | |
|---|---|
| Cyfluthrin | 0.39% |
| Perfluoro acrylate | 0.3% |
| Resin | 1% |
| Polyacrylate | 2% |
| Thickener | 0.23% |
| Add water up to | 100% |

### EXAMPLE 6

### Compositions of Lambda-Cyhalothrin Mixture (Weight/Weight)

| | |
|---|---|
| Lambda-cyhalothrin | 0.16% |
| Perfluoro acrylate | 0.3% |
| Resin | 1% |
| Polyacrylate | 2% |
| Thickener | 0.1% |
| Add water up to | 100% |

### EXAMPLE 7

### Compositions of Ethofenprox Mixture (Weight/Weight)

| | |
|---|---|
| Ethofenprox | 1.55% |
| Perfluoro acrylate | 0.3% |
| Resin | 1% |
| Polyacrylate | 2% |
| Thickener | 0.89% |
| Add water up to | 100% |

A process for preparing an insecticide mixture can be executed by dissolving a thickener in water and then slowly adding the insecticide while stirring strongly with a spinner. When they are well-mixed, the rest of components are added and stirred continuously. The fiber or fabric is then dipped in this mixture and dried at a heat at temperature of 150° C.-190° C. or, in other embodiments, at about 150° C.-190° C.

The insecticide according to the present invention also includes other pyrethroid substances or insecticides other than pyrethroid, which can be produced by using one or more types of insecticides, and which are helpful because of insecticide resistance of mosquitoes and insects in certain areas. In this case, the insecticide should be mixed with insecticide in another group in order to solve the problem of mosquito resistance to insecticide.

Adding an insect repellant or a synergist to the solution formula according to the present invention can be done using either an insect repellant or a synergist with a boiling point higher than the temperature used in the drying process. What is important is that it neither reacts with insecticide nor degrades the insecticide. The insect repellant added helps keep mosquitoes and insects away, while the synergist enhances efficiency in killing mosquitoes and insects.

Adding other types of substances to the formula of the insecticide mixture according to the present invention in order to improve the properties of the fiber or fabric or a mosquito net can also be carried out, for example, by adding a softener, a preservative, an UV protector, an anti-bacteria substance, or a combination of the foregoing, however, any reduction in the efficiency of the insecticide must be taken into consideration.

I claim:

1. A process for coating fiber or fabric with insecticide by dipping said fiber or fabric in an insecticide mixture comprising said insecticide and then subjecting said fiber or fabric to a temperature of about 150° C.-190° C.

2. The process of claim 1, wherein said insecticide mixture comprises said insecticide, a thickener, a fiber stabilizing enhancer, and water as a solvent.

3. The process of claim 2, wherein said thickener can dissolve in water and make a solution more viscous.

4. The process of claim 2, wherein said thickener is selected from the group consisting of starch, titanium dioxide, and gum.

5. The process of claim 4, wherein said thickener is a gum selected from compositions or derivatives of agar-agar, xanthan gum, alginate, carboxymethyl cellulose, carrageenan, lotus bean gum, pectin, karaya gum, acacia, guar, and tragacanth.

6. The process of claim 2, wherein said thickener is 1.01-10% of said insecticide mixture.

7. The process of claim 1, wherein said insecticide comprises a pyrethroid substance.

8. The process of claim 7, wherein said pyrethroid substance has a boiling point higher than 280° C.

9. The process of claim 7, wherein said pyrethroid substance is 0.1-10% of said insecticide mixture.

10. The process of claim 7, wherein said pyrethroid substance is selected from the group consisting of alpha-cypermethrin, esfenvalerate, ethofenprox, biphenthrin, flumethrin, cypermethrin, cyfluthrin, lambda-cyhalothrin, deltamethrin, and permethrin.

11. Fiber or fabric produced by the process comprising: dipping said fiber or fabric in an insecticide mixture comprising an insecticide and then subjecting said fiber or fabric to a temperature of about 150° C.-190° C.

12. The fiber or fabric of claim 11, wherein said insecticide mixture comprises said insecticide, a thickener, a fiber stabilizing enhancer, and water as a solvent.

13. The fiber or fabric of claim 12, wherein said thickener can dissolve in water and make a solution more viscous.

14. The fiber or fabric of claim 12, wherein said thickener is selected from the group consisting of starch, titanium dioxide, and gum.

15. The fiber or fabric of claim 14, wherein said thickener is a gum selected from compositions or derivatives of agar-agar, xanthan gum, alginate, carboxymethyl cellulose, carrageenan, lotus bean gum, pectin, karaya gum, acacia, guar, and tragacanth.

16. The fiber or fabric of claim 12, wherein said thickener is 1.01-10% of said insecticide mixture.

17. The fiber or fabric of claim 11, wherein said insecticide comprises a pyrethroid substance.

18. The fiber or fabric of claim 17, wherein said pyrethroid substance has a boiling point higher than 280° C.

19. The fiber or fabric of claim 17, wherein said pyrethroid substance is 0.1-10% of said insecticide mixture.

20. The fiber or fabric of claim 17, wherein said pyrethroid substance is selected from the group consisting of alpha-cypermethrin, esfenvalerate, ethofenprox, biphenthrin, flumethrin, cypermethrin, cyfluthrin, lambda-cyhalothrin, deltamethrin, and permethrin.
